(19) United States
(12) Patent Application Publication
(10) Pub. No.: US 2025/0148753 A1
(43) Pub. Date: May 8, 2025

(54) ADAPTIVE VIDEO COMPRESSION USING GENERATIVE MACHINE LEARNING

(71) Applicant: Microsoft Technology Licensing, LLC, Redmond, WA (US)

(72) Inventors: Roei Shlomo MENASHOF, Netanya (IL); Oren ISTRIN, Tel-Aviv (IL); Itamar LATNIK, Rishon Letzion (IL)

(21) Appl. No.: 18/504,038

(22) Filed: Nov. 7, 2023

(51) Int. Cl. G06V 10/74; G06F 40/40

(52) U.S. Cl. CPC G06V 10/761; G06F 40/40; G06V 2201/07

(57) ABSTRACT

Various embodiments of the technology described herein relate to compression of video data, including selecting a pivot image from a video including a plurality of images and causing a first machine learning model to generate a descriptor of the pivot image, where the descriptor includes a language description associated with the pivot image. In one example, the pivot image and the descriptor are provided to a decoder for reconstruction of the video. In an embodiment, the decoder includes a generative machine learning model that takes as an input the pivot image and the descriptor. The decoder uses the pivot image to generate an image based at least in part on the descriptor. The image is combined with other images generated by the generative machine learning model to reconstruct the video.

### BACKGROUND

A large portion of Internet traffic includes streaming media such as video and other graphical content. In addition, video is a common and versatile media form that can be used in a plurality of contexts such as education, entertainment, arts, and news. However, video streaming and transmission (e.g., over the Internet) is costly and challenging, consuming large amounts of computing resources, network bandwidth, and time. In addition, consumers of streaming video have expectations in terms of latency and video fidelity that can be difficult to achieve with the large amount of network traffic competing for computing resources. As such, video compression techniques can benefit both producers of video content and consumers.

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

Embodiments of the technology described herein related to video compression techniques that leverage generative machine learning and pivot images extracted from a video to preserve key concepts of the video while reducing file size and maintaining video fidelity. Embodiments of the technology described herein use a generative machine learning model to reconstruct a video (e.g., generate a reconstructed video) based at least in part on a set of pivot images extracted from an original video and corresponding pivot image descriptors. Embodiments of a generative machine learning model take as an input one or more pivot images, comprising frames extracted from a video and descriptors, and generate a set of images that can be combined to reconstruct the video.

In an illustrative example, an encoder generates the compressed video data by at least extracting pivot images from the video and generating pivot image descriptors. In an embodiment, the pivot images are selected based on an algorithm. For example, frames from the video can be sampled over an interval of time (e.g., ten milliseconds) or based on a number of frames (e.g., 20 frames). In other examples, the pivot images are selected based at least in part on the content of the frame of the video. Embodiments of the encoder include an object detection model (e.g., neural network) that detects objects and/or backgrounds within frames of the video and selects pivot images based at least in part on the detected objects and/or backgrounds. In one illustrative example, a change in the number of objects detected by the object detection model between successive frames of the video causes the encoder to select the frame as a pivot image. In such embodiments, the encoder (e.g., using the object detection model or other machine learning models) analyzes frames of the video and extracts key concepts within the video as pivot images.

Furthermore, in various embodiments, the encoder includes a large language model (LLM) or other natural language model to generate descriptors of the pivot images. For example, the descriptors can include natural language descriptions of the objects, backgrounds, interactions, and concepts included in the pivot images. The descriptors of the pivot images along with the pivot image, in various embodiments, represent the compressed video and can be provided to a decoder to reconstruct the video. In addition, in various embodiments, the compression of the video can be adjusted (e.g., via a user input) by modifying the number of pivot images and/or the length and number of descriptors.

Embodiments of the decoder include one or more generative machine learning models (e.g., Generative Pre-trained Transformers [GPT], Gaussian mixture models, and diffusion models) that generate the video based on the data provided by the encoder, such as the set of pivot images and the descriptors. For example, a generative machine learning model included in the decoder takes as an input a set of pivot images and corresponding descriptor and generates a set of transition images and/or frames between consecution pivot images in order to reconstruct the video. In addition, by implementing the decoder at the user device, in various embodiments, the amount of data transmitted for streaming video is reduced while the level of fidelity of the video is maintained. Furthermore, in such embodiments, encoding metrics can be extended beyond pixel-level fidelity of existing technologies. For example, as a result of the generative model being capable of reconstructing the video at the same or higher level of fidelity, encoding metrics can be used to assess or otherwise determine a degree to which the reconstructed video conveys key concepts and/or ideas of the original content.

Whereas certain existing technologies allow for the reduction in the size of a video file and/or video data, the resulting video has lower fidelity and still requires a relatively large amount of computing resources to facilitate streaming and/or transmission of the video due to the limitations of compression.

The present disclosure provides one or more technical solutions that have technical effects in light of various technical problems. For example, particular embodiments have the technical effect of improving the compression rate of video data while maintaining the fidelity and conceptual information of the video. Instead of reducing the size of the video data by eliminating redundant data, for example, particular embodiments result in compressed video data that includes pivot images and descriptors that can be used to recreate the video without any loss in fidelity while greatly reducing the amount and/or size of the video data. Accordingly, one technical solution is the use of multi-modal generative machine learning models to determine pivot images that include key concepts and/or events of a video, generate natural langue descriptors of the pivot images, and reconstruct the video. Accordingly, the amount of network traffic required for streaming video services and/or video transmission is reduced, allowing those computing resources to be used for other tasks. For example, instead of transmitting a one mega-byte (MB) compressed video stream over a network to a viewer, only forty-five kilobytes (KB) of a relatively small number of pivot images and descriptors (e.g., text) are transmitted.

### BRIEF DESCRIPTION OF THE DRAWINGS

The present disclosure is described in detail below with reference to the attached drawing figures, wherein:

FIG. 1 is a block diagram of an example operating environment suitable for implementations of the present disclosure;

FIG. 2 is a block diagram of an example system including an encoder to generate compressed video data used by a decoder to reconstruct a video, in accordance with an embodiment of the present disclosure;

FIG. 3 is a flow diagram generating and displaying compressed video data, in accordance with an embodiment of the present disclosure;

FIG. 4 is a flow diagram for generating compressed video data, in accordance with an embodiment of the present disclosure;

FIG. 5 is a flow diagram of generating a video based on compressed video data, in accordance with an embodiment of the present disclosure;

FIG. 6 is a block diagram of a language model that uses particular inputs to make particular predictions, in accordance with an embodiment of the present disclosure;

FIG. 7 is a block diagram of an example computing environment suitable for use in implementing an embodiment of the present disclosure; and

FIG. 8 is a block diagram of an example computing environment suitable for use in implementing an embodiment of the present disclosure.

### DETAILED DESCRIPTION

The subject matter of aspects of the present disclosure is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described. Each method described herein may comprise a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few.

Various embodiments discussed herein are directed to generating compressed video data including pivot images and descriptors that can be used as an input to a generative machine learning model to reconstruct the video data. For example, an encoder can extract pivot images from a video and generate (e.g., using a multi-modal generative model such as Generative Pre-trained Transformers [GPT]) natural language descriptors of the pivot images. Continuing this example, a decoder obtains the pivot images and descriptors and causes the generative machine learning model to generate a set of images based on the pivot images and descriptors and combines the set of images in order to reconstruct or otherwise generate the video. In this manner the key conceptual elements of the video are maintained and generated by the decoder or component thereof (e.g., the generative machine learning model) while the amount of data transmitted between the encoder and the decoder is reduced.

In general, compression techniques rely on eliminating or reducing redundant data and are limited by various constraints including video and audio fidelity. In addition, the focus on maintaining fidelity limits the effectiveness of compression techniques. In addition, video compression is necessary in order to share or otherwise transmit videos on the Internet because compression reduces the amount of data that is needed to stream or send the video to the viewer, and network bandwidth is a limited resource. One way to address this issue is by using a video coding format (e.g., a video compression format), which is a content representation format for storage or transmission of digital video content (e.g., in a data file or bitstream). Typically these formats use a video compression algorithm, such as discrete cosine transform (DCT) coding or motion compensation.

However, these video compression techniques can reduce the quality of the original video, resulting in visual artifacts such as blockiness, pixelation, blurring, and ringing. In addition, these artifacts can affect the viewing experience and the accuracy of video analysis. Furthermore, video compression increases computing resource usage (e.g., processor utilization) required for encoding and decoding video, which can decrease the performance and efficiency of the devices involved in encoding and decoding the video. Video compression can also introduce errors or distortions during transmission of the compressed video over a network such as the Internet as a result of data loss, corruption of video frames, and/or synchronization issues between audio and video. Lastly, the motion complexity and/or texture of the video content can reduce the efficiency and quality of the compressed video.

With this in mind, embodiments discussed herein provide a technical solution to the deficiencies and limitations of existing technologies associated with video compression. In one embodiment, a generative machine learning model reconstructs or otherwise generates a video based on data that preserves key concepts and/or elements of the original video. In one embodiment, encoding of the compressed video if performed by at least selecting a subset of frames (e.g., pivot images) of the video and causing a machine learning model to generate natural language descriptors of the subset of frames and/or frames of the video between the subset of frames. In one embodiment, quality metrics of the compressed video and/or the video displayed to the viewer (e.g., the video generated by the decoder) evaluate the preservation of video concepts and/or elements. Determination of the quality metrics, in one example, is based on an amount or degree to which the reconstructed video conveys ideas and/or maintains the narrative coherence of the original video.

In more detail, a video compression tool includes an encoder that generates, based on a video, a compressed video (e.g., data file, data object, data stream, etc.,) to be reconstructed by a decoder executed by a user device for display to a viewer. In one example, generative machine learning models are used to generate descriptors of pivot images extracted from the video and reconstruct the video based on the descriptors and the pivot images. As used herein, a “generative machine learning model” refers to various types and/or combinations of machine learning models that generate data such as text, images, or other data based on an input. Example generative machine learning models include LLMs (e.g., GPT-4, LLAMA-2, Bard) and Diffusion models (e.g., DALL-E 2, Stable Diffusion, and Midjourney.). In one example, the encoder extracts frames from the video and uses a generative machine learning model to generate natural language descriptions of the frames, objects within the frames, and/or natural language descriptions of relationships between frames.

To help illustrate, suppose the video to be compressed includes a static background and a soccer ball moving along a path over the background. In this example, the encoder extracts every tenth frame of the video and causes a first generative machine model to generate a descriptor for the extracted frames (e.g., a natural language description of the soccer ball and the location). In this example, the extracted frames are selected based on an interval of time (e.g., every tenth frame), although, as described in greater detail below, other algorithms can be used for selecting frames of the video to be extracted. Continuing the example, the extracted frames (e.g., pivot images) and corresponding descriptors are provided to the decoder, which reconstructs the original video based on the extracted frames and descriptors. For example, a second machine learning model modifies the extracted frames based on the descriptors to move the location of the soccer ball along the path over the background.

In one embodiment, the encoder includes one or more machine learning models that take the video as an input and extract the pivot images and generate the descriptors. In one example, a first machine learning model detects changes between frames of the video (e.g., a change to objects between frames of the video, change to a background or location within the video, a change in a concept or tone conveyed by the video, etc.) and selects pivot images based at least in part on the detected change. Returning to the example above, the first machine learning model selects a particular frame as a pivot image based on the detection of a second soccer ball. Continuing this example, the first machine learning model or another machine learning model can then generate a descriptor of the change. For example, “a second soccer ball appears at pixel location (x:240, y:−123).” In other embodiments, a Large Language Model (LLM) generates descriptions of frames of the video, and selection of pivot images is performed based on the description generated by the LLM. For example, a pivot image is selected based on the LLM describing a new object in a particular frame.

In one embodiment, the decoder includes one or more generative machine learning models that take pivot images (e.g., frames extracted from the video) as an input and descriptors (e.g., natural language descriptions of the pivot images, non-extracted frames of the video, other components of the video, and/or concepts, themes, or other information associated with the video) and generates a set of images. In one example, the set of images generated by the generative model are combined to reconstruct the original video compressed by the encoder. For example, a viewer can stream a video over a network (e.g., the Internet) by at least obtaining the compressed video from the encoder or other device (e.g., a server computer system operating a storage service of a computing resource service provider) and causing the decoder to reconstruct the video.

In one embodiment, the generative machine learning model included in the decoder generates the set of images by at least modifying the pivot images based on the descriptors. In one example, the pivot image includes an image of a flamingo standing in a body of water, and the corresponding descriptor describes the flamingo taking flight. Continuing this example, based on this input, the generative model generates a set of images that include the flamingo taking flight. Furthermore, in various embodiments, the generative model generates the set of images by at least modify the pivot images (e.g., adding noise to the pivot images and denoising the pivot images to generate new images). In yet other embodiments, the generative model generates entirely new images for the set of images. For example, the generative model uses the pivot images and the descriptors as a basis to generate frames of the reconstructed video. In some embodiments, a mask is used to remove the objects in the pivot images and generate a background for the generative model and the objects to be modified by the generative model.

Particular embodiments have the technical effect of improved compression of videos include streaming videos. This is because various embodiments implement the technical solutions of using generative machine learning models to generate compressed video data and reconstructing the original video based on the compressed video data. Compression techniques are often limited by the need to maintain audio and video fidelity. In addition, compression techniques can introduce unwanted artifacts and/or errors in the compressed video data, require additional computing resources to reconstruct, and are limited in the amount of data that can be removed. One significantly more efficient alternative is employing at least one generative model that is capable of reconstructing the video based on a relatively small subset of frames of the video compared to the entire video and textual data.

Certain embodiments have the technical effect of reduced computational resource consumption required to stream or otherwise transmit video data over a network. As discussed above, video data comprises a large portion of Internet traffic. However, compression techniques do little to reduce the amount of computational resources required to stream video. As discussed herein, certain embodiments allow for the algorithmic selection and/or extraction of pivot images that maintain the fidelity of the video and concepts of the video while greatly reducing the amount of data that needs to be transmitted. In this manner, the streaming video over a network such as the Internet requires fewer computing resources and network bandwidth.

Additionally, certain embodiments have the technical effect of improving encoding quality metrics. Currently, compression metrics are focused on pixel-level fidelity. To the extent that certain existing approaches allow video data to be compressed, the resulting video fidelity is lower than the original video. However, embodiments described herein allow for the reconstruction of video data at the same or greater fidelity. Therefore, certain embodiments have the technical effect of improving quality metrics by allowing the focus of the metrics to be directed toward maintenance and/or conveyance of conceptual elements of the original video in the reconstructed video.

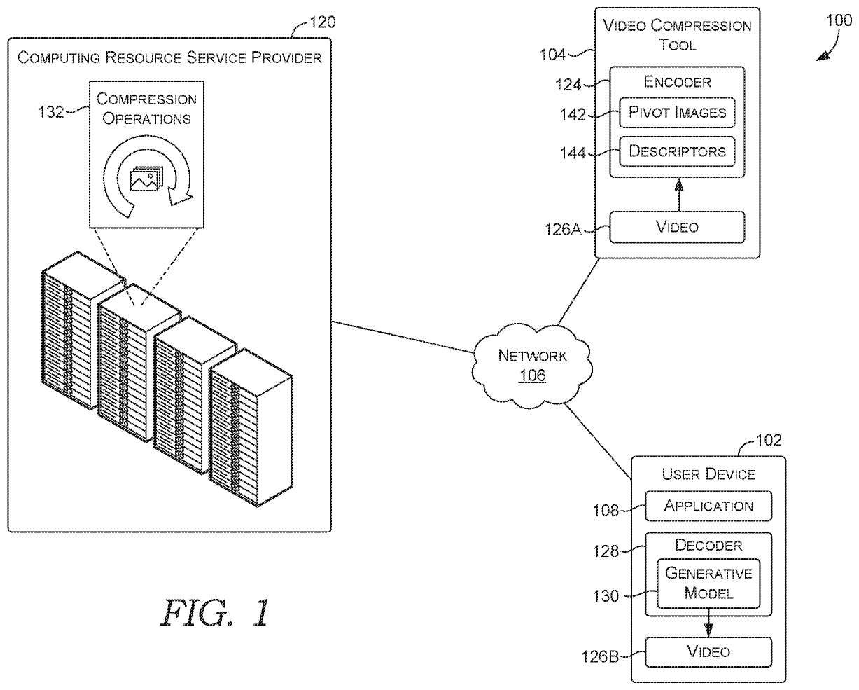

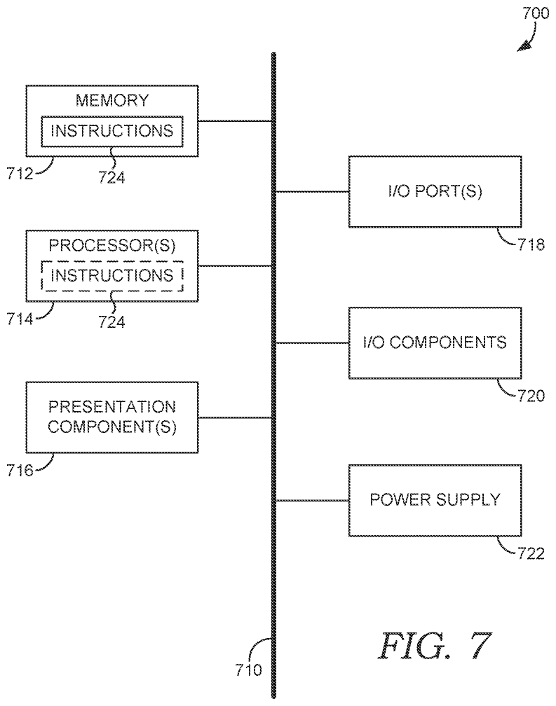

Turning to FIG. 1, FIG. 1 is a diagram of an operating environment 100 in which one or more embodiments of the present disclosure can be implemented. It should be understood that this and other arrangements described herein are set forth only as examples. Other arrangements and elements (e.g., machines, interfaces, functions, orders, and groupings of functions, etc.) can be used in addition to or instead of those shown, and some elements can be omitted altogether for the sake of clarity. Further, many of the elements described herein are functional entities that can be implemented as discrete or distributed components or in conjunction with other components, and in any suitable combination and location. Various functions described herein as being performed by one or more entities can be carried out by hardware, firmware, and/or software. For instance, some functions can be carried out by a processor executing instructions stored in memory, as further described with reference to FIG. 7.

It should be understood that operating environment 100 shown in FIG. 1 is an example of one suitable operating environment. Among other components not shown, operating environment 100 includes a user device 102, video compression tool 104, a computing resource service provider 120, and a network 106. Each of the components shown in FIG. 1 can be implemented via any type of computing device, such as one or more computing devices 700 described in connection with FIG. 7, for example. These components can communicate with each other via network 106, which can be wired, wireless, or both. Network 106 can include multiple networks, or a network of networks, but is shown in simple form so as not to obscure aspects of the present disclosure. By way of example, network 106 can include one or more wide area networks (WANs), one or more local area networks (LANs), one or more public networks such as the Internet, and/or one or more private networks. Where network 106 includes a wireless telecommunications network, components such as a base station, a communications tower, or even access points (as well as other components) can provide wireless connectivity. Networking environments are commonplace in offices, enterprise-wide computer networks, intranets, and the Internet. Accordingly, network 106 is not described in significant detail.

It should be understood that any number of devices, servers, and other components can be employed within operating environment 100 within the scope of the present disclosure. Each can comprise a single device or multiple devices cooperating in a distributed environment. For example, the video compression tool 104 includes multiple server computer systems cooperating in a distributed environment to perform the operations described in the present disclosure. In an embodiment, the video compression tool 104 is provided or otherwise implemented as a service of the computing resource service provider 120.

User device 102 can be any type of computing device capable of being operated by an entity (e.g., individual or organization) and obtains data from video compression tool 104 and/or the computing resource service provider 120 (e.g., from a data store) which can be facilitated by the computing resource service provider 120. The user device 102, in various embodiments, has access to or otherwise displays the video 126B. For example, the application 108 includes a video streaming application, including a decoder 128 that obtains compressed video data from the video compression tool 104 and displays the video 126B to one or more viewers.

In some implementations, user device 102 is the type of computing device described in connection with FIG. 7. By way of example and not limitation, the user device 102 can be embodied as a personal computer (PC), a laptop computer, a mobile device, a smartphone, a tablet computer, a smart watch, a wearable computer, a personal digital assistant (PDA), a global positioning system (GPS) or device, a video player, a handheld communications device, a gaming device or system, an entertainment system, a vehicle computer system, an embedded system controller, a remote control, an appliance, a consumer electronic device, a workstation, any combination of these delineated devices, or any other suitable device.

The user device 102 can include one or more processors and one or more computer-readable media. The computer-readable media can also include computer-readable instructions executable by the one or more processors. In an embodiment, the instructions are embodied by one or more applications, such as application 108 shown in FIG. 1. Application 108 is referred to as a single application for simplicity, but its functionality can be embodied by one or more applications in practice.

In various embodiments, the application 108 includes any application capable of facilitating the exchange of information between the user device 102 and the video compression tool 104. For example, the application 108 operates as a user interface to a streaming service provided by the computing resource service provider. In some implementations, the application 108 comprises a web application, which can run in a web browser, and can be hosted at least partially on the server-side of the operating environment 100. In addition, or instead, the application 108 can comprise a dedicated application, such as an application being supported by the user device 102 and the decoder 128. In some cases, the application 108 is integrated into the operating system (e.g., as a service). It is therefore contemplated herein that “application” be interpreted broadly.

For cloud-based implementations, for example, the application 108 is utilized to interface with the functionality implemented by the video compression tool 104 and/or computing resource service provider. In some embodiments, the components, or portions thereof, of the video compression tool 104 are implemented on the user device 102 or other systems or devices. Thus, it should be appreciated that the application 108, in some embodiments, is provided via multiple devices arranged in a distributed environment that collectively provide the functionality described herein. Additionally, other components not shown can also be included within the distributed environment.

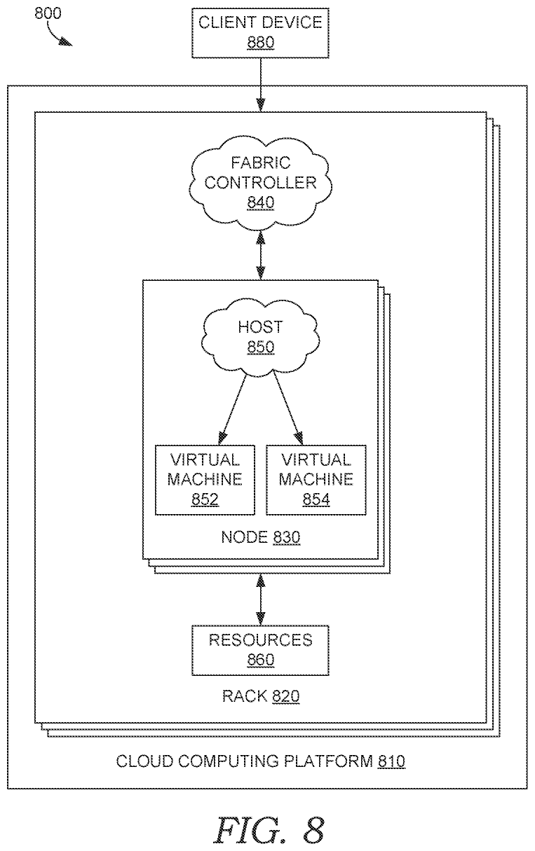

In various embodiments, the computing resource service provider 120 includes a plurality of computing devices that provide a multi-tenant environment in which computing devices (e.g., operated by users) are provided access to computing resources of the computing resource service provider 120. In one example, the computing devices operated by the computing resource service provider 120 include the type of computing device described in connection with FIG. 7. In other examples, the computing devices operated by the computing resource service provider 120 include the type of cloud computing architecture described in connection with FIG. 8. Furthermore, in an embodiment, the computing resource service provider 120 provides a plurality of services that can be used to access the computing resources (e.g., sever computer systems, network devices, storage devices, etc.). For example, the services provided by the computing resource service provider 120 include compute services, storage services, video streaming services, networking services, or other services that allow computing devices to access computing resources. In an embodiment, the video compression tool 104 is provided as a service of the computing resources service provider 120.

As illustrated in FIG. 1, the video compression tool 104 generates compressed video data based on a video 126A. In an embodiment, the video compression tool 104 and/or encoder 124 of the video compression tool 104 uses computing resources of the computing resource service provider 120 to perform compression operations 132. In one example, the compression operations 132 include generating pivot images 142 and descriptors 144 based at least in part on the video 126A. In an embodiment, the compression operations 132 include other operations such as eliminating redundant data, combining data, storing data, or other operations to generate the compressed video data. In one example, the compression operations 132 includes generating a data object (e.g., a data file in an archived file format such as .ZIP), including the pivot images 142 and the descriptors 144.

In an embodiment, the video 126A includes an electronic representation of moving visual images in the form of encoded digital data. In one example, the video 126A includes series of images that when displayed in rapid succession (e.g., at thirty frames per second) generate the electronic representation of moving visual images on a display device (e.g., a display device of the user device 102). In an embodiment, the video 126A is captured and/or stored in an uncompressed format (e.g., Advance Video Coding [H.264] or Moving Picture Expert Group-4 [MPEG-4]).

In various embodiments, the video 126A is streamed or otherwise transmitted over the network 106. For example, streaming the video 126A is the process of transmitting video data over the Internet in real-time or near-real-time, which allows viewers (e.g., a user) to watch the video 126A on the user device 102 (e.g., without downloading the entire video 126A prior to viewing). In an embodiment, the video 126A is streamed from a physical and/or virtual server operated by the computing resource service provider 120 to the user device 102 over the network 106 to deliver audio and video elements using various protocols such as HyperText Transfer Protocol (HTTP), Transmission Control Protocol/Internet Protocol (TCP/IP), and/or HyperText Markup Language (HTML).

In an embodiment, the video compression tool 104 compresses the video 126A prior to streaming or otherwise transmitting data to the user device 102. For example, the encoder 124 encodes or otherwise generates compressed video data, based at least in part on the video 126A, which is streamed to the user device 102. As described herein, the compressed video data includes, in an embodiment, the pivot images 142 and the descriptors 144. Furthermore, the compressed video data, in some embodiments, can include additional data beyond the pivot images 142 and the descriptors 144. For example, the compressed video data can include data identifying a source of the video, an author of the video, the encoder 124, one or more machine learning models used to generate the compressed video data, or other data that can be used by the decoder 128 to generate, display, or otherwise process the compressed video data.

In various embodiments, the pivot images 142 include a subset of frames and/or images from the video 126A. In one example, the pivot images 142 are extracted from the video 126A based at least in part on a number of frames. Continuing this example, the encoder 124 extracts every tenth frame of the video 126A. In other embodiments, one or more machine learning models are used to determine key frames and/or conceptual elements of the video 126A in order to determine the pivot images. In one example, an object detection model (e.g., scale-invariant feature transforms [SIFT], Convolutional Neural Network [CNN], Video Object Detection [VOD], Region-based Convolutional Neural Network [R-CNN], Single-shot Detector [SSD], Detection Transformer [DETR], etc.) is used to detect objects in images (e.g., frames) of the video 126A.

Continuing this example, the encoder 124 selects the pivot images 142 based at least in part on the objects detected in a particular image of the video 126A. For example, the encoder 124 selects a particular image as a pivot image if the location of an object changes, the number of objects changes, the size or shape of an object changes, the color of an object changes, or any other modification to objects within the image. In various embodiments, the output of the object detection model from a plurality of images of the video 126A are compared. For example, the output of the object detection model for consecutive frames of the video 126A is compared by the encoder 124 to select the pivot images 142. In another example, the output of the object detection model for every tenth frame of the video 126A is compared by the encoder 124 to select the pivot images 142.

In yet other embodiments, a large language model (LLM) generates a description of images of the video 126A, and the encoder 124 selects the pivot images based at least in part on the output of the LLM. In one example, an image (e.g., frame) is extracted from the video 126A and provided to the LLM as an input. In such embodiments, the LLM then outputs a natural language description of the image 126. Continuing this example, the encoder 124 then selects pivot images 142 based at least in part on the output of the LLM. For example, the encoder 124 selects a pivot image based on the length of the output, a number of objects described in the output, a concept described in the output, an action described in the output, or other attribute of the output. In an embodiment, the output of the LLM is compared for a plurality of frames. For example, if the output of the LLM includes the description of a new object or is longer than a previous output the encoder selects the corresponding frame as a pivot image. In yet other embodiments, the input to the LLM can include a portion or the entirety of the video 126A. For example, the LLM can generate a description of a scene or other discrete portion of the video.

In some embodiments, a combination of machine learning models and/or algorithms can be used to determine the pivot images 142. In one example, the object detection model is used to process every tenth frame of the video 126A. In another example, if the object detection model detects a modification to an object within a frame of the video, the LLM is used to generate a description of the frame. Various combinations of machine learning models can be used to determine the set of pivot images 142 such that concepts included in the video 126A are captured by the pivot images 142.

In an embodiment, the descriptors 144 include data that can be provided to the decoder 128 or component thereof (e.g., a generative machine learning model 130) to generate or otherwise reconstruct the video 126B. In one example, the descriptors 144 are generated based at least in part on the video 126A and/or pivot images 142. In an embodiment, an LLM or other machine learning model (e.g., GPT, bidirectional encoder representations from transformers [BERT], CNN, etc.) takes, as an input, the video 126A and/or pivot images 142 and outputs a natural language description that is used by the encoder 124 to generate the descriptors 144. For example, the encoder 124, after extracting a particular pivot image, provides the particular pivot image as an input to the LLM, and the LLM then generates a prompt (e.g., natural language description) that guides a generative machine learning model of the decoder 128 to an image. In other example, the video 126A and the pivot images 142 are provided to the LLM and the LLM generates the descriptors 144 based at least in part on frames of the video 126A between the pivot images 142. In a specific example, the video 126A includes a background with two trees and a cat running between the trees, the pivot images 142 include a first image of the cat at the first tree and a second image of the cat at the second tree. Continuing this specific example, the descriptors 144 include a description of the conceptual elements of the video 126A (e.g., the cat running from the first tree to the second tree). In various embodiments, the descriptors 144 are modified or otherwise used to generate a set of prompts for the generative model 130.

In various embodiments, the descriptors 144 include a natural language description of a corresponding pivot image. Furthermore, the level and/or amount of description generated can be variable based on various aspects of the system, such as the amount of compression required, method of selecting pivot images, type of generative machine learning model used, number of generative machine learning models used, or other aspects of the environment 100. In one example, the descriptors 144 include the location and/or motion of objects in the pivot images 142. In another example, the descriptors 144 include a description of the video 126A between successive pivot images. In an embodiment, the encoder 124 modifies the output from the LLM or other machine learning model to generate the descriptors 144. For example, the natural language descriptions of the pivot images 142 generated by the LLM or other machine learning model are modified or otherwise used to generate prompts to a text-to-image model (e.g., DALL-E 2).

In various embodiments, the generative model 130 included in the decoder 128 takes the pivot images 142 and the descriptors 144 as an input and generates a plurality of images based at least in part on the input, the plurality of images that are combined to generate the video 126B (e.g., the plurality of images are used as frames of the video 126B). In one example, the generative machine learning model 130 includes a neural network that takes images and natural language as an input and generates an image. In various embodiments, the generative machine learning model 130 is trained to modify the pivot images 142 or otherwise use the pivot images 142 to generate frames of the video 126B by at least moving objects within the pivot images 142 based on the descriptors 144 to recreate or otherwise reconstruct the video 126A. In this manner, a quality metric associated with the encoder 124 and/or decoder 128 includes a measure of a similarity between the reconstructed video 126B and original video 126A (e.g., how well the video 126B maintains conceptual elements of the video 126A).

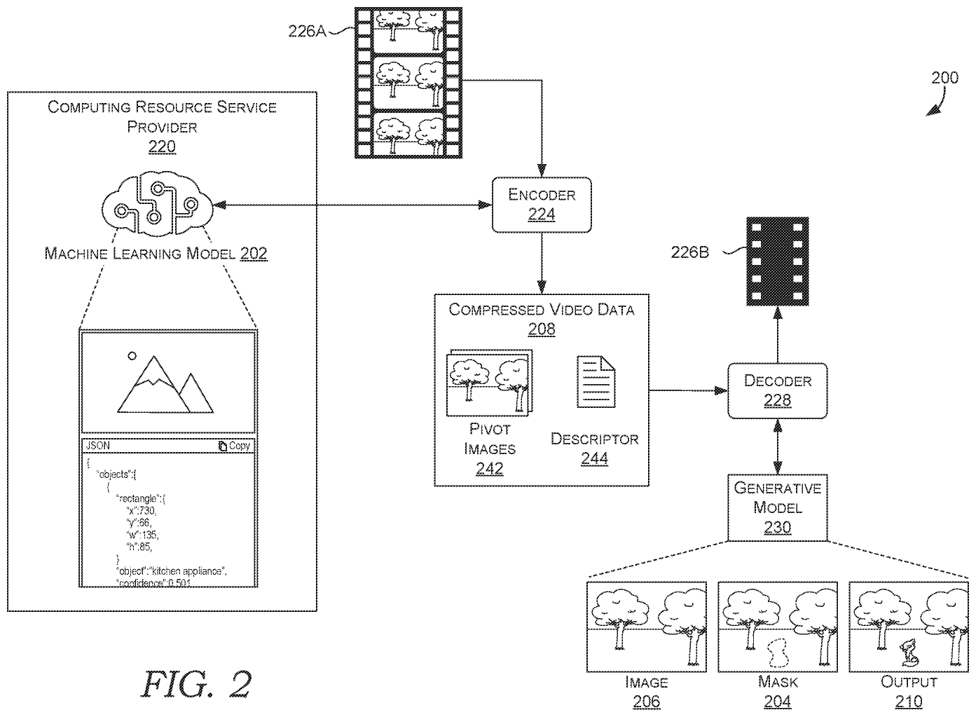

Referring now to FIG. 2, depicted is a block diagram of an example system 200 including an encoder 224 that generates compressed video data 208 based at least in part on a video 226A and a decoder 228 that generates or otherwise reconstructs a video 226B based at least in part on the compressed video data 208. The illustrated encoder 224 uses a machine learning model that extracts pivot images 242 from the video 226A and generate descriptors 244. In one example, the pivot images 242 and the descriptors are included in the compressed video data 208. The illustrated decoder 228 includes a generative model 230 that takes the compressed video data as an input and generates the video 226B.

In some embodiments, the video 226A is obtained from a streaming service or other service of a computing resource service provider 220. In one example, the video 226A includes previously recorded multimedia data (e.g., recorded audio and video). In another example, the video 226A is streamed or otherwise recorded in real-time (e.g., a live video broadcast). In an embodiment, the video 226A is obtained from a storage device over a network, such as from a storage service that transmits data over the Internet. In some embodiments, the video 226A is maintained in a service of the computing resource service provider 220. Furthermore, in some examples, the computing resource service provider 220 provides the encoder 224 and/or the machine learning model 202 as a service.

In an embodiment, the encoder 224 generates the compressed video data 208. For example, using computing resources of the computing resource service provider 220, the encoder 224 extracts a set of pivot images 242 from the video 226A. In one embodiment, the pivot images 242 are selected from a subset of the frames of the video 226. For example, the pivot images 242 are selected from every tenth frame, every second, or other subset of frames of the set of frames of the video 226A. In other embodiments, the machine learning model 202 determines the set of pivot images 242.

The machine learning model 202, in various embodiments, includes one or more machine learning models trained to perform various tasks described in connection with the present disclosure. For example, the machine learning model 202 includes an object detection model, as described above in connection with FIG. 1 (e.g., SIFT, CNN, R-CNN, SSD, DETR, etc.) that detects objects within frames of the video 226A. Continuing this example, the machine learning model 202 selects pivot images 242 based at least in part on objects within the frames of the video 226A. As described above in connection with FIG. 1, the pivot images 242 include frames and/or images from the video 226A that include conceptual elements of the video 226A. In an embodiment, a particular frame of the video 226A is selected as a pivot image as a result of the machine learning model 202 detecting a modification to an object or a number of objects in the particular frame relative to at least one other frame.

### Artificial Intelligence (AI) System Overview

An artificial intelligence (AI) system refers to an artificial intelligence computing environment or architecture that includes the infrastructure and components that support the development, training, and deployment of artificial intelligence models. It provides necessary hardware, software, and frameworks for developers to create and run artificial intelligence applications. An artificial intelligence system may be a cloud-based AI solution that leverages cloud computing infrastructure to develop, train, deploy, and manage AI models and applications. AI models may specifically refer to generative AI models that are designed to generate new data or content that is similar to, or in some cases, entirely different from data they are trained on.

Artificial intelligence systems can include transformer models that are capable of running complex neural language processing tasks. Transformer models—also known as Large Language Models (LLMs)—have applications in a wide range of industries. An LLM is a trained deep-learning model that can recognize, summarize, translate, predict, and generate content using very large datasets. LLMs and other types of generative AI models are associated with a training phase—where a model is taught to learn patterns, relationships, and knowledge from training datasets; and an inference phase, which includes making predictions, classifications, or generating outputs for real-world tasks or queries.

Unlike convolution neural networks, which are typically used for image tasks and mostly rely on convolution operations, transformer models are based on simple general matrix multiplication (GEMM) tasks, which can be further broken down to perform a dot product operation on two vectors. While CNN architectures are typically computationally heavy with a relatively small number of parameters, the architecture of transformer models results in the opposite-a very large number of parameters, with a fairly small number of operations. The LLM architecture can create challenges in that performance bottlenecks reside in the memory throughput and capacity rather than the compute engine.

Transformer models operate with memory accesses to retrieve a matrix of weights out of memory, together with a vector (either the input vector or partial result from previous stage of the model), and multiplying the two. This is true for the model's attention sub-layers, the FFN (feed-forward network), sub-layers, and for the final embedding layer. As vector-matrix multiplication is actually comprised of numerous vector-vector multiplications (dot product), it is fair to say that most memory accesses are used to read two vectors in order to perform a dot product on them. As such reading out the full vectors is inefficient.

As such, transformer models (also referred to herein a “generative AI models”) require computational resources including processors and memory for the training phase and inference phase. The generative AI models operate with different types of processors (e.g., central processing units [CPUs] or graphics processing unit [GPUs]) in architectures that include multi-core CPUs or parallel processors including GPUs and TPUs. Memory can be used to store model parameters and intermediate data for the training phase and the inference phase. Memory requirements may depend on the size and the architecture of the generative AI models. By way of illustration, an LLM can support an inferencing phase that includes using a trained model to make predictions, draw conclusions, or generate output based on input data or patterns learned during the model's training phase. During the inference phase, an LLM can use DRAM (Dynamic Random Access Memory) to store various components and data for making inferences. LLMs can store their pre-trained model parameters (e.g., weights and biases of the neural network layers) in DRAM, and when a new input is provided for inference, the model accesses these parameters from DRAM to make predictions.

The inference phase can be divided into two stages: a prompt stage and an auto-regressive stage. The prompt stage can include receiving and processing input as a batch of new tokens as part of the same inference. The prompt stage may operate based on a Key-Value (KV) cache technique, where a KV cache is created for tokens in a batch. During the prompt stage, the input is being digested. The auto-regressive state can include using the model to generate the tokens one-by-one, based on previous tokens, relying on reading the KV cache of previously-processed tokens, and adding the data of the new of only new tokens to the KV cache. This auto-regressive stage includes the model generating a response to the input from the prompt stage.

Returning to FIG. 2, in various other embodiments, other types of machine learning models can be used alone or in combination to determine the set of pivot images 242. For example, an LLM is provided frames of the video 226A, as an input, and generates a natural language description of the frames. In various embodiments, the natural language description of the frames is used (e.g., by the encoder 224) to determine the pivot images 242. For example, the encoder 224 selects a particular frame as a pivot image based at least in part on a number of objects described in the natural language description of the particular frame, a number of objects described in the natural language description of the particular frame relative to at least one other frame, a length of the natural language description, a comparison of the natural language description of the particular frame and at least one other frame, or other attribute of the natural language description of the particular frame.

Once the pivot images 242 are extracted or otherwise selected, in various embodiments, the encoder 224 generates the descriptors 244. As described above in connection with FIG. 1, the descriptors 244 include natural language descriptions of the pivot images 242 to be provided to the generative model 230. In one example, the pivot images 242 are provided, as an input, to the machine learning model 202, and the machine learning model 202 outputs the descriptors 244. Continuing this example, the machine learning model 202 includes an LLM that generates prompts for the generative model 230 to enable the generative model 230 to reconstruct the video 226B based at least in part on the pivot images 242.

In various embodiments, the compressed video data 208 is stored by the computing resource service provider 220 or other entity (e.g., edge network device). Furthermore, the compressed video data 208, in an embodiment, is provided to the decoder 228 executed by a computing device, such as the user device 102 described above in connection with FIG. 1. The decoder 228, upon obtaining the compressed video data 208, in one example, causes the generative model 230 to generate a set of images which the decoder 228 combines to generate the video 226B. As described above in connection with FIG. 1, the generative model 230 includes various machine learning models such as GPTs, LLMs, diffusion models, neural networks, or other machine learning models to generate an image based at least in part on an image (e.g., a pivot image) and a corresponding description (e.g., a descriptor).

In various embodiments, the generative model 230 generates an output 210 based at least in part on an image 206 and a mask 204. In one example, the image 206 includes a pivot image, and the mask 204 includes a layer and/or set of pixels that covers or otherwise hides an object in the pivot image. Continuing this example, the generative model 230 then uses the mask 204 to move an object within the image 206 to generate the output 210. In other embodiments, the generative model 230 is trained to generate the output 210 based at least in part on the pivot images without the use of the mask 204. In one example, the generative model 230 takes as an input pivot images that include two trees and a cat, as shown in FIG. 2, and moves the location of the cat based at least in part on a location indicated in the descriptor 244. In such embodiments, the generative model 230 is trained to modify or otherwise use the pixels or other elements of the pivot images 242 to generate an image (e.g., a frame of the reconstructed video) based at least in part on the natural language description included in the descriptors 244.

In various embodiments, the generative model 230 is trained video data, pivot images, and descriptors in order to generate similar data. In one example, noise or other random or pseudorandom data is added to the training data (e.g., forward diffusion process) and the generative model 230 is trained by at least removing the noise (e.g., reverse diffusion process) to recreate or otherwise reconstruct the training data. Once the generative model 230 is trained, in various embodiments, a sampling procedure is used to generate the output 210. In one example, the output 210 is generated by at least providing Gaussian noise or other random or pseudorandom sample noise to the generative model 230 which then performs denoising.

The descriptors 244, in various embodiments, are provided to the generative model 230 as a prompt and a text encoder of the generative model 230 maps the prompt to a representation space, where the representation space includes an image encoding that captures the semantic information of the prompt. In such embodiments, an image decoder of the generative model 230 stochastically generates an image that includes visual components corresponding to the semantic information.

In one example, the generative model 230 reconstructs the video by at least adding noise to the pivot images 242 and denoising the resulting images (e.g., the pivot images 242 with noise added) based at least in part on semantic information or other information included in the descriptors 244. Continuing this example, the generative model 230 continues this process to generate a frame of the reconstructed video that can be displayed to the viewer. In an embodiment, the generative model 230 generates a set of frames for the reconstructed video based at least in part on a frame rate provided by the decoder 228 or other entity (e.g., the user device 102 described above in connection with FIG. 1).

In the example illustrated in FIG. 2, where the pivot images 242 include two trees and the descriptor 244 describes the motion of a cat between the two trees, the generative model 230 generates a plurality of frames (e.g., the output 210) where successive frames move the cat between the two tree as indicated in the descriptors 244 (e.g., using the denoising process described above). Furthermore, in some embodiments, the mask 204 is used to remove objects from the pivot images 242 prior to adding noise and performing the denoising process to generate frames of the reconstructed video.

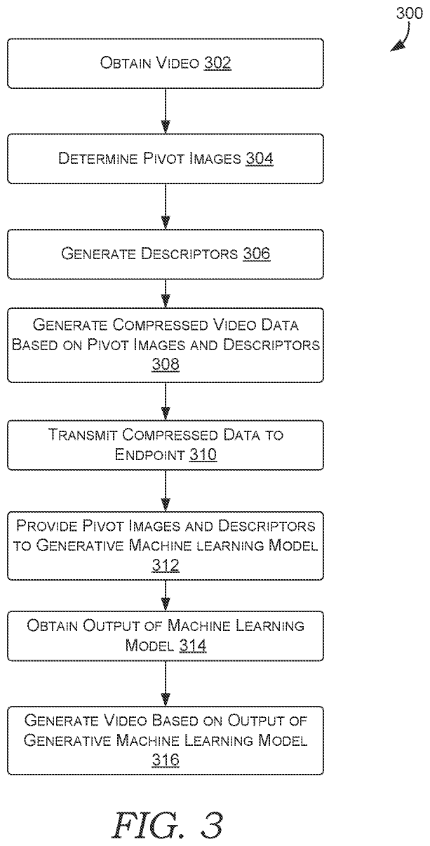

FIG. 3 is a flow diagram showing a method 300 for compressing video data for display to a user in accordance with at least one embodiment. The method 300 can be performed, for instance, by the video compression tool 104 and/or decoder 128 of FIG. 1. Each block of the methods 300, 400, and 500 or any other methods described herein comprises a computing process performed using any combination of hardware, firmware, and/or software. For instance, various functions can be carried out by a processor executing instructions stored in memory. The methods can also be embodied as computer-usable instructions stored on computer storage media. The methods can be provided by a standalone application, a service or hosted service (standalone or in combination with another hosted service), or a plug-in to another product, to name a few.

As shown at block 302, the system implementing the method 300 obtains a video. As described above in connection with FIG. 1, in various embodiments, the video is obtained by an encoder to generate compressed video data. In one example, the encoder is operated by a streaming media service that transmits compressed video data to user devices for display to a viewer. At block 304, the system implementing the method 300 determines pivot images to include in the compressed video data based at least in part on the video. For example, the encoder determines frames of the video that convey conceptual information associated with the video. As described above, several algorithmic techniques can be used to determine or otherwise select pivot images. In one example, a subset of the frames of the video are sampled based at least in part on an interval of time and/or number of frames. In other examples, a machine learning model is used to select pivot images based at least in part on a number of objects included in a frame.

At block 306, the system implementing the method 300 generates descriptors based at least in part on the pivot images and/or video. In one example, an LLM or other machine learning model generates descriptors based at least in part on the pivot images. The descriptors, in an embodiment, include natural language descriptions of the pivot images. In other embodiments, the descriptors include structured data (e.g., a JavaScript Object Notation [JSON] file) that indicates attributes (e.g., location, movement, size, shape, etc.) of objects within the pivot images. For example, the descriptors include text-based data (e.g., data, pseudo-code, source code, etc.) that is provided to a generative model of an encoder to enable the generative model to reconstruct the video. In an embodiment, descriptors are generated for the video and/or portions thereof (e.g., frames between pivot images).

At block 308, the system implementing the method 300 generates compressed video data based at least in part on the pivot images and descriptors. In one example, the pivot images and descriptions are combined into a single archive data object. In some examples, additional information and/or data is included in the compressed video data. At block 310, the system implementing the method 300 transmits the compressed data to an endpoint. In one example, a user device requests the video and, in response, the compressed video data is transmitted to the user device.

At block 312, the system implementing the method 300 provides the pivot images and descriptors to a generative machine learning model. As described above, a decoder obtains the pivot images and descriptors, and using a generative machine learning model (e.g., diffusion model), generates a set of output images, in accordance with various embodiments. At block 314, the system implementing the method 300 obtains the output of the machine learning model. In one example, the pivot images include frames from the video and the descriptors describe the movement of objects or other conceptual elements between the pivot images and the generative machine learning model takes the pivot images and descriptors as inputs and outputs images that include the pivot images and movement of objects or other conceptual elementals indicated in the descriptors. In this example, the set of images output from the generative model reconstructs the video.

At block 316, the system implementing the method 300 generates the video based at least in part on the output of the generative machine learning model. For example, the decoder generates a video by at least combing the output images obtained from the generative machine learning model. In some examples, the decoder generates the video once all of the output images have been generated by the generative machine learning model. In other examples, the decoder generates and displays (e.g., streams) the video while the generative machine learning model is still generating outputs based at least in part on pivot images and descriptors.

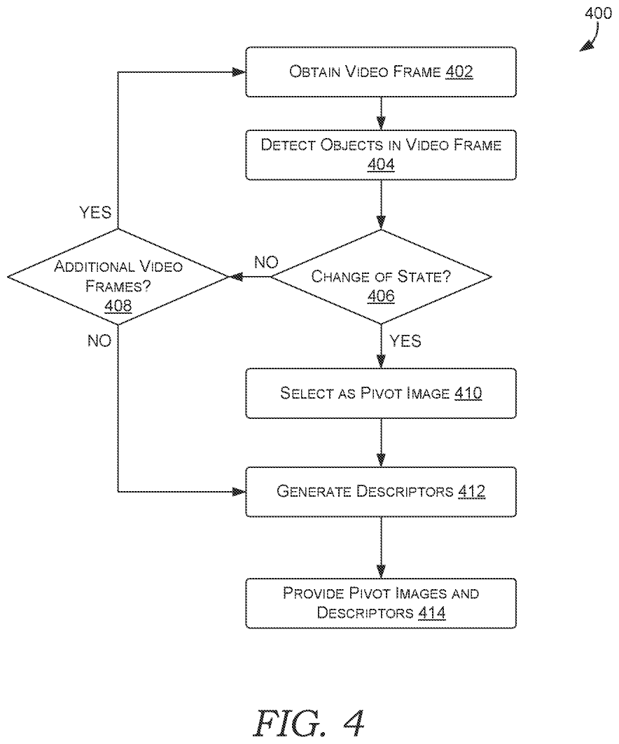

FIG. 4 is a flow diagram showing a method 400 for generating pivot images and descriptors for compressed video data, in accordance with at least one embodiment. The method 400 can be performed, for instance, by the encoder 124 of the video compression tool 104 of FIG. 1. As shown at block 402, the system implementing the method 300 obtains a video frame. In various embodiments, a video is obtained, and individual frames of the video (e.g., video frames) are extracted and/or processed. At block 404, the system implementing the method 400 determines and/or detects objects in the video frame. For example, as described above, an object detection model takes the video frame as an input and outputs data associated with objects in the video frame (e.g., labels, confidence intervals, tags, names, type information etc.).

At block 406, the system implementing the method 400 determines whether there is a change of state in an object depicted in the video frame. For example, the system implementing the method 400 compares the number of objects detected in a previous frame to the number of objects detected in the video frame. Furthermore, in another example, the system implementing the method 400 detects other changes of state, such as position, size, shape, orientation, or other aspects of an object that can convey conceptual information in a video. If no change of state is detected, the system implementing the method 400 continues to block 408. At block 408, the system implementing the method 400 determines whether additional video frames are present in the video. If there are additional video frames (e.g., the video has not terminated), the system implementing the method 400 continues the method 400 at block 402 and obtains the next video frame. If no additional video frames are included in the video, the method 400 continues to block 412 described below.

Returning to block 406 above, if a change of state is detected, the system implementing the method 400 continues to block 410 and selects the video frame as a pivot image. For example, the video frame is extracted and stored as a pivot image. At block 412, the system implementing the method 400 generates descriptors. As described above, in various embodiments, the descriptors include textual data such as natural language descriptions associated with the pivot images and/or video. For example, the pivot images are provided to an LLM that generates natural language descriptions of the pivot images and/or conceptual elements connecting or otherwise associated with the pivot images. At block 414, the system implementing the method 400 provides the pivot images and descriptors. For example, the pivot images and descriptors are transmitted to a decoder executed by a user device.

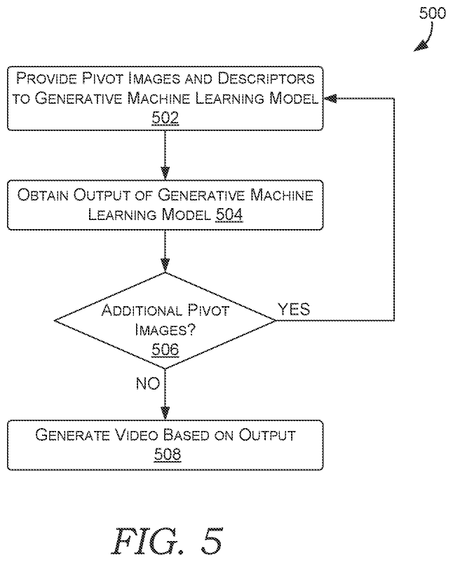

FIG. 5 is a flow diagram showing a method 500 for reconstructing a video based at least in part on compressed video data for display to a viewer in accordance with at least one embodiment. The method 500 can be performed, for instance, by the decoder 128 of FIG. 1. As shown at block 502, the system implementing the method 300 obtains pivot images and descriptors to a generative machine learning model. As described above in connection with FIG. 1, in various embodiments, compressed video data includes a set of pivot images and descriptors that are provided as an input to the generative machine learning model. In one example, the generative machine learning model generates output images by at least modifying the pivot images based at least in part on the descriptors.

At block 504, the system implementing the method 500 obtains the output of the generative machine learning model. At block 506, if there are additional pivot images and/or descriptors, the system implementing the method 500 returns to block 502 and continues the method 500. However, if there are no additional pivot images and/or descriptors, the system implementing the method 500 continues to block 508. At block 508, the system implementing the method 500 generates the video based at least in part on the output of the generative machine learning model. For example, the set of images generated as the output of the generative model are combined to reconstruct the video.

### OTHER EMBODIMENTS

In some embodiments, a computerized system, such as the computerized system described in any of the embodiments above, comprises a memory component, and a processing device coupled to the memory component, the processing device to perform operations. The operations comprise obtaining a video comprising a plurality of images and selecting a pivot image from the plurality of images. The operations may further comprise causing a first machine learning model to generate a descriptor based at least in part on the pivot image by at least providing the pivot image as an input to the first machine learning model, where the descriptor includes a language description of the pivot image and providing the pivot image and the descriptor to a decoder. Advantageously in this way, these embodiments of this disclosure enable improved compression rate for video data while maintaining sufficient fidelity and conceptual information of the video. Also in this way, embodiments, as described herein, reduce the amount of network traffic and computing resources required for streaming video services and/or video transmission, thereby allowing those computing resources to be used for other tasks.

In any combination of the above embodiments of the computerized system, the pivot image depicts a conceptual element of the video.

In any combination of the above embodiments of the computerized system, the operations further comprise selecting the pivot image further comprises selecting the pivot image from the plurality of images based on a second machine learning model detecting a change between two or more images of the plurality of images.

In any combination of the above embodiments of the computerized system, the change comprises a modification to an object depicted in the two or more images that is detected, by the second machine learning model.

In any combination of the above embodiments of the computerized system, the operations further comprise detecting, by the second machine learning model, an additional object relative to at least one image of the two or more images.

In any combination of the above embodiments of the computerized system, the operations further comprise prompting the first machine learning model to describe a conceptual element of the video relative to the pivot image and at least one other image of the plurality of images.

In any combination of the above embodiments of the computerized system, the operations further comprise causing, at the decoder, a third machine learning model to generate a reconstructed video by at least providing as a first input to the third machine learning model the pivot image and the descriptor, where the third machine learning model uses the pivot image and at least a portion of the descriptor to output a second plurality of images that are combined to generate the reconstructed video.

In any combination of the above embodiments of the computerized system, the first machine learning model comprises a large language model, the second machine learning model comprises a neural network, and the third machine learning model comprises a diffusion model.

In other embodiments, a non-transitory computer-readable medium storing executable instructions embodied thereon, that, when executed by a processing device, cause the processing device to perform operations. The operations comprise obtaining a pivot image from a video and causing a machine learning model to generate a descriptor based at least in part on the pivot image, the descriptor providing a natural language description of the pivot image. The operations may further comprise generating a compressed data object including the descriptor and the pivot image and providing the compressed data object to an endpoint over a network. Advantageously in this way, these embodiments of this disclosure enable improved compression rate for video data while maintaining sufficient fidelity and conceptual information of the video. Also in this way, embodiments, as described herein, reduce the amount of network traffic and computing resources required for streaming video services and/or video transmission, thereby allowing those computing resources to be used for other tasks.

In any combination of the above embodiments of the medium, the operations further comprise causing a decoder executed by the endpoint to generate a reconstructed video by at least providing the descriptor and the pivot image as an input to a generative model.

In any combination of the above embodiments of the medium, the generative model generates intermediate frames of the reconstructed video between the pivot image and a second pivot image based at least in part on the descriptor.

In any combination of the above embodiments of the medium, the operations further comprise sampling frames of the video over an interval of time.

In any combination of the above embodiments of the medium, the operations further comprise causing a second machine learning model to determine the pivot image includes a conceptual element of the video.

In any combination of the above embodiments of the medium, the operations further comprise causing the machine learning model to generate a second descriptor that includes a second natural language description of a relationship between the set of pivot images and at least one other pivot image obtained from the video, where the pivot image of the at least one other pivot image are provided to the machine learning model as an input.

In any combination of the above embodiments of the medium, the machine learning model includes a large language model (LLM).

In any combination of the above embodiments of the medium, the operations further comprise causing the machine learning model to generate a second natural language description of a frame of the video and selecting the frame as the pivot image based at least in part on the second natural language description.

In other embodiments, a method is provided. The method includes obtaining a descriptor and a pivot image, the descriptor including a natural language description associated with the pivot image generated by a first machine learning model, the pivot image extracted from a video and causing a second machine learning model to generate reconstructed video based at least in part on the pivot image and the descriptor. Advantageously in this way, these embodiments of this disclosure enable improved compression rate for video data while maintaining sufficient fidelity and conceptual information of the video. Also in this way, embodiments, as described herein, reduce the amount of network traffic and computing resources required for streaming video services and/or video transmission, thereby allowing those computing resources to be used for other tasks

In any combination of the above embodiments of the method, the descriptor further includes a second natural language description of objects within the pivot image.

In any combination of the above embodiments of the method, the method includes causing the second machine learning model to generate the reconstructed video further comprises causing the second machine learning model to reconstruct a first version of the video.

In any combination of the above embodiments of the method, the method includes causing the second machine learning model to generate the reconstructed video further comprises combining a plurality of images generated by the second machine learning model based at least in part on the pivot image and the descriptor.

### Example Computing Environments

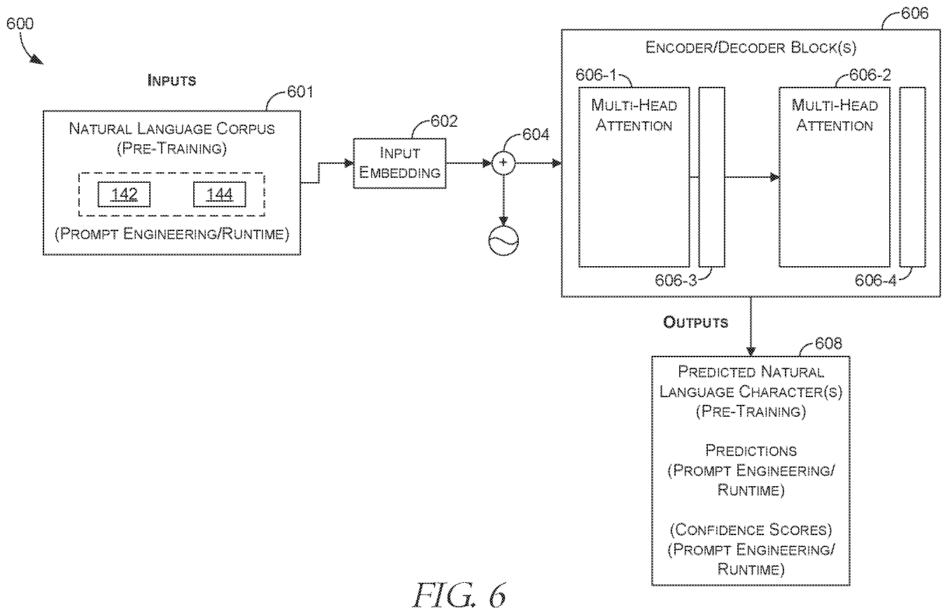

Having described various implementations, several example computing environments suitable for implementing embodiments of the disclosure are now described, including an example computing device and an example distributed computing environment in FIGS. 6, 7, and 8, respectively. FIG. 6 is a block diagram of a language model 600 (for example, a BERT model or Generative Pre-trained Transformer [GPT]-4 model) that uses particular inputs to make particular predictions (for example, answers to questions), according to some embodiments. In one embodiment, the language model 600 corresponds to the machine learning model 202 described herein. For example, this model 600 represents or includes the functionality as described with respect to the machine learning model 202 or the generative model 130 and 230 of FIGS. 1 and 2. In various embodiments, the language model 600 includes one or more encoders and/or decoder blocks 606 (or any transformer or portion thereof).

First, a natural language corpus (for example, various WIKIPEDIA English words or BooksCorpus) of the inputs 601 are converted into tokens and then feature vectors and embedded into an input embedding 602 to derive meaning of individual natural language words (for example, English semantics) during pre-training. In some embodiments, to understand English language, corpus documents, such as text books, periodicals, blogs, social media feeds, and the like are ingested by the language model 600.

In some embodiments, each word or character in the input(s) 601 is mapped into the input embedding 602 in parallel or at the same time, unlike existing long short-term memory (LSTM) models, for example. The input embedding 602 maps a word to a feature vector representing the word. But the same word (for example, “apple”) in different sentences may have different meanings (for example, phone versus fruit). This is why a positional encoder 604 can be implemented. A positional encoder 604 is a vector that gives context to words (for example, “apple”) based on a position of a word in a sentence. For example, with respect to a message “I just sent the document,” because “I” is at the beginning of a sentence, embodiments can indicate a position in an embedding closer to “just,” as opposed to “document.” Some embodiments use a sine/cosine function to generate the positional encoder vector using the following two example equations:

$${PE}_{( pos , 2 i )} = sin ( pos / {10000}^{2 i / {d}_{model}} ) \qquad ( 1 )$$

$${PE}_{( pos , 2 i + 1 )} = cos ( pos / {10000}^{2 i / {d}_{model}} ) . \qquad ( 2 )$$

After passing the input(s) 601 through the input embedding 602 and applying the positional encoder 604, the output is a word embedding feature vector, which encodes positional information or context based on the positional encoder 604. These word embedding feature vectors are then passed to the encoder and/or decoder block(s) 606, where it goes through a multi-head attention layer 606-1 and a feedforward layer 606-2. The multi-head attention layer 606-1 is generally responsible for focusing or processing certain parts of the feature vectors representing specific portions of the input(s) 601 by generating attention vectors. For example, in Question-Answering systems, the multi-head attention layer 606-1 determines how relevant the i^{th} word (or particular word in a sentence) is for answering the question or relevant to other words in the same or other blocks, the output of which is an attention vector. For every word, some embodiments generate an attention vector, which captures contextual relationships between other words in the same sentence or other sequences of characters. For a given word, some embodiments compute a weighted average or otherwise aggregate attention vectors of other words that contain the given word (for example, other words in the same line or block) to compute a final attention vector.

In some embodiments, a single-headed attention has abstract vectors Q, K, and V that extract different components of a particular word. These are used to compute the attention vectors for every word, using the following equation (3):

$$Z = soft max ( \frac{Q \cdot {K}^{T}}{\sqrt{Dimension of vector Q , K or V}} ) . V . \qquad ( 3 )$$

For multi-headed attention, there are multiple weight matrices W^{q}, W^{k} and W^{v} so there are multiple attention vectors Z for every word. However, a neural network may expect one attention vector per word. Accordingly, another weighted matrix, W^{z}, is used to make sure the output is still an attention vector per word. In some embodiments, after the layers 606-1 and 606-2, there is some form of normalization (for example, batch normalization and/or layer normalization) performed to smoothen out the loss surface making it easier to optimize while using larger learning rates.

Layers 606-3 and 606-4 represent residual connection and/or normalization layers where normalization re-centers and rescales or normalizes the data across the feature dimensions. The feedforward layer 606-2 is a feed-forward neural network that is applied to every one of the attention vectors outputted by the multi-head attention layer 606-1. The feedforward layer 606-2 transforms the attention vectors into a form that can be processed by the next encoder block or make a prediction at 608. For example, given that a document includes first natural language sequence “the due date is . . . ,” the encoder/decoder block(s) 606 predicts that the next natural language sequence will be a specific date or particular words based on past documents that include language identical or similar to the first natural language sequence.

In some embodiments, the encoder/decoder block(s) 606 includes pre-training to learn language (pre-training) and make corresponding predictions. In some embodiments, there is no fine-tuning because some embodiments perform prompt engineering or learning. Pre-training is performed to understand language, and fine-tuning is performed to learn a specific task, such as learning an answer to a set of questions (in Question-Answering [QA] systems).

In some embodiments, the encoder/decoder block(s) 606 learns what language and context for a word is in pre-training by training on two unsupervised tasks (Masked Language Model [MLM] and Next Sentence Prediction [NSP]) simultaneously or at the same time. In terms of the inputs and outputs, at pre-training, the natural language corpus of the inputs 601 may be various historical documents, such as textbooks, journals, and periodicals, in order to output the predicted natural language characters in 608 (not make the predictions at runtime or prompt engineering at this point). The example encoder/decoder block(s) 606 takes in a sentence, paragraph, or sequence (for example, included in the input [s] 601), with random words being replaced with masks. The goal is to output the value or meaning of the masked tokens. For example, if a line reads, “please [MASK] this document promptly,” the prediction for the “mask” value is “send.” This helps the encoder/decoder block(s) 606 understand the bidirectional context in a sentence, paragraph, or line at a document. In the case of NSP, the encoder/decoder block(s) 606 takes, as input, two or more elements, such as sentences, lines, or paragraphs, and determines, for example, if a second sentence in a document actually follows (for example, is directly below) a first sentence in the document. This helps the encoder/decoder block(s) 606 understand the context across all the elements of a document, not just within a single element. Using both of these together, the encoder/decoder block(s) 606 derives a good understanding of natural language.

In some embodiments, during pre-training, the input to the encoder/decoder block(s) 606 is a set (for example, two) of masked sentences (sentences for which there are one or more masks), which could alternatively be partial strings or paragraphs. In some embodiments, each word is represented as a token, and some of the tokens are masked. Each token is then converted into a word embedding (for example, 602). At the output side is the binary output for the next sentence prediction. For example, this component may output 1, for example, if masked sentence 2 followed (for example, was directly beneath) masked sentence 1. The outputs are word feature vectors that correspond to the outputs for the machine learning model functionality. Thus, the number of word feature vectors that are input is the same number of word feature vectors that are output.

In some embodiments, the initial embedding (for example, the input embedding 602) is constructed from three vectors: the token embeddings, the segment or context-question embeddings, and the position embeddings. In some embodiments, the following functionality occurs in the pre-training phase. The token embeddings are the pre-trained embeddings. The segment embeddings are the sentence numbers (that includes the input [s] 601) that is encoded into a vector (for example, first sentence, second sentence, and so forth, assuming a top-down and right-to-left approach). The position embeddings are vectors that represent the position of a particular word in such a sentence that can be produced by positional encoder 604. When these three embeddings are added or concatenated together, an embedding vector is generated that is used as input into the encoder/decoder block(s) 606. The segment and position embeddings are used for temporal ordering since all of the vectors are fed into the encoder/decoder block(s) 606 simultaneously, and language models need some sort of order preserved.

In pre-training, the output is typically a binary value C (for NSP) and various word vectors (for MLM). With training, a loss (for example, cross-entropy loss) is minimized. In some embodiments, all the feature vectors are of the same size and are generated simultaneously. As such, each word vector can be passed to a fully connected layered output with the same number of neurons equal to the same number of tokens in the vocabulary.

In some embodiments, after pre-training is performed, the encoder/decoder block(s) 606 performs prompt engineering or fine-tuning on a variety of QA data sets by converting different QA formats into a unified sequence-to-sequence format. For example, some embodiments perform the QA task by adding a new question-answering head or encoder/decoder block, just the way a masked language model head is added (in pre-training) for performing an MLM task, except that the task is a part of prompt engineering or fine-tuning. This includes the encoder/decoder block(s) 606 processing the inputs (e.g., pivot images 142 and/or descriptors 144 of FIG. 1) in order to make the predictions and generate a prompt response, as indicated in 604. Prompt engineering, in some embodiments, is the process of crafting and optimizing text prompts for language models to achieve desired outputs. In other words, prompt engineering comprises a process of mapping prompts (for example, a question) to the output (for example, an answer) that it belongs to for training. For example, if a user asks a model to generate a poem about a person fishing on a lake, the expectation is it will generate a different poem each time. Users may then label the output or answers from best to worst. Such labels are an input to the model to make sure the model is giving a more human-like or best answers, while trying to minimize the worst answers (for example, via reinforcement learning). In some embodiments, a “prompt” as described herein includes one or more of: a request (for example, a question or instruction [for example, “write a poem”]), target content, and one or more examples, as described herein.

In some embodiments, the inputs 601 additionally or alternatively include other inputs, such as the inputs to machine learning models described in FIGS. 1-5. In an illustrative example, the predictions of the output represent a descriptor for a pivot image, set of pivot images, video, or portion of a video from the initial prompt and contextual information described herein. For instance, the predictions may be generative text, such as a natural language description of an image or set of images, a generative answer to a question, machine translation text, or other generative text. Alternative to prompt engineering, certain embodiments of inputs (or the inputs or prompts sent to or received by the machine learning models described in FIGS. 1-5) represent inputs provided to the encoder/decoder block(s) 608 at runtime or after the model 600 has been trained, tested, and deployed. Likewise, in these embodiments, the predictions in the output 608 represent predictions made at runtime or after the model 600 has been trained, tested, and deployed.

With reference to FIG. 7, an example computing device is provided and referred to generally as computing device 700. The computing device 700 is but one example of a suitable computing environment and is not intended to suggest any limitation as to the scope of use or functionality of embodiments of the disclosure, and nor should the computing device 700 be interpreted as having any dependency or requirement relating to any one or combination of components illustrated.

Embodiments of the disclosure are described in the general context of computer code or machine-useable instructions, including computer-useable or computer-executable instructions, such as program modules, being executed by a computer or other machine such as a smartphone, a tablet PC, or other mobile device, server, or client device. Generally, program modules, including routines, programs, objects, components, data structures, and the like, refer to code that performs particular tasks or implements particular abstract data types. Embodiments of the disclosure are practiced in a variety of system configurations, including mobile devices, consumer electronics, general-purpose computers, more specialty computing devices, or the like. Embodiments of the disclosure are also practiced in distributed computing environments where tasks are performed by remote-processing devices that are linked through a communications network. In a distributed computing environment, program modules may be located in both local and remote computer storage media, including memory storage devices.

Some embodiments comprise an end-to-end software-based system that operates within system components described herein to operate computer hardware to provide system functionality. At a low level, hardware processors generally execute instructions selected from a machine language (also referred to as machine code or native) instruction set for a given processor. The processor recognizes the native instructions and performs corresponding low-level functions related to, for example, logic, control, and memory operations. Low-level software written in machine code can provide more complex functionality to higher level software. Accordingly, in some embodiments, computer-executable instructions include any software, including low-level software written in machine code, higher level software such as application software, and any combination thereof. In this regard, the system components can manage resources and provide services for system functionality. Any other variations and combinations thereof are contemplated within the embodiments of the present disclosure.

With reference to FIG. 7, computing device 700 includes a bus 710 that directly or indirectly couples the following devices: memory 712, one or more processors 714, one or more presentation components 716, one or more input/output (I/O) ports 718, one or more I/O components 720, and an illustrative power supply 722. In one example, bus 710 represents one or more buses (such as an address bus, data bus, or combination thereof). Although the various blocks of FIG. 7 are shown with lines for the sake of clarity, in reality, these blocks represent logical, not necessarily actual, components. For example, a presentation component includes a display device, such as an I/O component. Also, processors have memory. The inventors hereof recognize that such is the nature of the art and reiterate that the diagram of FIG. 7 is merely illustrative of an example computing device that can be used in connection with one or more embodiments of the present disclosure. Distinction is not made between such categories as “workstation,” “server,” “laptop,” or “handheld device,” as all are contemplated within the scope of FIG. 7 and with reference to “computing device.”

Computing device 700 typically includes a variety of computer-readable media. Computer-readable media can be any available media that can be accessed by computing device 700 and includes both volatile and non-volatile, removable and non-removable media. By way of example, and not limitation, computer-readable media comprises computer storage media and communication media. Computer storage media includes both volatile and non-volatile, removable and non-removable media implemented in any method or technology for storage of information such as computer-readable instructions, data structures, program modules, or other data. Computer storage media includes, but is not limited to, random-access memory (RAM), read-only memory (ROM), electrically erasable programmable read-only memory (EEPROM), flash memory or other memory technology, CD-ROM, digital versatile disks (DVDs) or other optical disk storage, magnetic cassettes, magnetic tape, magnetic disk storage or other magnetic storage devices, or any other medium that can be used to store the desired information and which can be accessed by computing device 700. Computer storage media does not comprise signals per se. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner so as to encode information in the signal. By way of example, and not limitation, communication media includes wired media, such as a wired network or direct-wired connection, and wireless media, such as acoustic, radio frequency (RF), infrared, and other wireless media. Combinations of any of the above should also be included within the scope of computer-readable media.

Memory 712 includes computer storage media in the form of volatile and/or non-volatile memory. In one example, the memory is removable, non-removable, or a combination thereof. Hardware devices include, for example, solid-state memory, hard drives, and optical-disc drives. Computing device 700 includes one or more processors 714 that read data from various entities such as memory 712 or I/O components 720. As used herein and in one example, the term processor or “a processer” refers to more than one computer processor. For example, the term processor (or “a processor”) refers to at least one processor, which may be a physical or virtual processor, such as a computer processor on a virtual machine. The term processor (or “a processor”) also may refer to a plurality of processors, each of which may be physical or virtual, such as a multiprocessor system, distributed processing or distributed computing architecture, cloud computing system, or parallel processing by more than a single processor. Further, various operations described herein as being executed or performed by a processor are performed by more than one processor.

Presentation component(s) 716 presents data indications to a user or other device. Presentation components include, for example, a display device, speaker, printing component, vibrating component, and the like.

The I/O ports 718 allow computing device 700 to be logically coupled to other devices, including I/O components 720, some of which are built in. Illustrative components include a microphone, joystick, game pad, satellite dish, scanner, printer, or a wireless device. The I/O components 720 can provide a natural user interface (NUI) that processes air gestures, voice, or other physiological inputs generated by a user. In some instances, inputs are transmitted to an appropriate network element for further processing. An NUI may implement any combination of speech recognition, touch and stylus recognition, facial recognition, biometric recognition, gesture recognition both on screen and adjacent to the screen, air gestures, head and eye tracking, and touch recognition associated with displays on the computing device 700. In one example, the computing device 700 is equipped with depth cameras, such as stereoscopic camera systems, infrared camera systems, red-green-blue (RGB) camera systems, and combinations of these, for gesture detection and recognition. Additionally, the computing device 700 may be equipped with accelerometers or gyroscopes that enable detection of motion. The output of the accelerometers or gyroscopes may be provided to the display of the computing device 700 to render immersive augmented reality or virtual reality.

Some embodiments of computing device 700 include one or more radio(s) 724 (or similar wireless communication components). The radio transmits and receives radio or wireless communications. Example computing device 700 is a wireless terminal adapted to receive communications and media over various wireless networks. Computing device 700 may communicate via wireless protocols, such as code-division multiple access (“CDMA”), Global System for Mobile (“GSM”) communication, or time-division multiple access (“TDMA”), as well as others, to communicate with other devices. In one embodiment, the radio communication is a short-range connection, a long-range connection, or a combination of both a short-range and a long-range wireless telecommunications connection. In various embodiments, references to “short” and “long” types of connections do not refer to the spatial relation between two devices. Instead, in general references to short range and long range as different categories, or types, of connections (for example, a primary connection and a secondary connection). A short-range connection includes, by way of example and not limitation, a Wi-Fi® connection to a device (for example, mobile hotspot) that provides access to a wireless communications network, such as a wireless local area network (WLAN) connection using the 802.11 protocol; a Bluetooth connection to another computing device is a second example of a short-range connection, or a near-field communication connection. A long-range connection may include a connection using, by way of example and not limitation, one or more of Code-Division Multiple Access (CDMA), General Packet Radio Service (GPRS), Global System for Mobile Communication (GSM), Time-Division Multiple Access (TDMA), and 802.16 protocols.

Referring now to FIG. 8, an example distributed computing environment 800 is illustratively provided, in which implementations of the present disclosure can be employed. In particular, FIG. 8 shows a high-level architecture of an example cloud computing platform 810 that can host a technical solution environment or a portion thereof (for example, a data trustee environment). It should be understood that this and other arrangements described herein are set forth only as examples. For example, as described above, many of the elements described herein are implemented as discrete or distributed components or in conjunction with other components, and in any suitable combination and location. Other arrangements and elements (for example, machines, interfaces, functions, orders, and groupings of functions) can be used in addition to or instead of those shown.

Data centers can support distributed computing environment 800 that includes cloud computing platform 810, rack 820, and node 830 (for example, computing devices, processing units, or blades) in rack 820. The technical solution environment can be implemented with cloud computing platform 810, which runs cloud services across different data centers and geographic regions. Cloud computing platform 810 can implement the fabric controller 840 component for provisioning and managing resource allocation, deployment, upgrade, and management of cloud services. Typically, cloud computing platform 810 acts to store data or run service applications in a distributed manner. Cloud computing platform 810 in a data center can be configured to host and support operation of endpoints of a particular service application. In one example, the cloud computing platform 810 is a public cloud, a private cloud, or a dedicated cloud.

Node 830 can be provisioned with host 850 (for example, operating system or runtime environment) running a defined software stack on node 830. Node 830 can also be configured to perform specialized functionality (for example, computer nodes or storage nodes) within cloud computing platform 810. Node 830 is allocated to run one or more portions of a service application of a tenant. A tenant can refer to a customer utilizing resources of cloud computing platform 810. Service application components of cloud computing platform 810 that support a particular tenant can be referred to as a multi-tenant infrastructure or tenancy. The terms “service application,” “application,” or “service” are used interchangeably with regards to FIG. 8, and broadly refer to any software, or portions of software, that run on top of, or access storage and computing device locations within, a datacenter.

When more than one separate service application is being supported by nodes 830, certain nodes 830 are partitioned into virtual machines (for example, virtual machine 852 and virtual machine 854). Physical machines can also concurrently run separate service applications. The virtual machines or physical machines can be configured as individualized computing environments that are supported by resources 860 (for example, hardware resources and software resources) in cloud computing platform 810. It is contemplated that resources can be configured for specific service applications. Further, each service application may be divided into functional portions such that each functional portion is able to run on a separate virtual machine. In cloud computing platform 810, multiple servers may be used to run service applications and perform data storage operations in a cluster. In one embodiment, the servers perform data operations independently but exposed as a single device, referred to as a cluster. Each server in the cluster can be implemented as a node.

In some embodiments, client device 880 is linked to a service application in cloud computing platform 810. Client device 880 may be any type of computing device, such as user device 102 described with reference to FIG. 1, and the client device 880 can be configured to issue commands to cloud computing platform 810. In embodiments, client device 880 communicates with service applications through a virtual Internet Protocol (IP) and load balancer or other means that direct communication requests to designated endpoints in cloud computing platform 810. Certain components of cloud computing platform 810 communicate with each other over a network (not shown), which includes, without limitation, one or more local area networks (LANs) and/or wide area networks (WANs).

### Additional Structural and Functional Features of Embodiments of Technical Solution

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (for example, machines, interfaces, functions, orders, and groupings of functions) can be used in addition to or instead of those shown.

Embodiments described in the paragraphs below may be combined with one or more of the specifically described alternatives. In particular, an embodiment that is claimed may contain a reference, in the alternative, to more than one other embodiment. The embodiment that is claimed may specify a further limitation of the subject matter claimed.

For purposes of this disclosure, the word “including” has the same broad meaning as the word “comprising,” and the word “accessing” comprises “receiving,” “referencing,” or “retrieving.” Furthermore, the word “communicating” has the same broad meaning as the word “receiving” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

As used herein, the term “set” may be employed to refer to an ordered (i.e., sequential) or an unordered (i.e., non-sequential) collection of objects (or elements), such as machines (for example, computer devices), physical and/or logical addresses, graph nodes, graph edges, functionalities, and the like. As used herein, a set may include N elements, where N is any positive integer. That is, a set may include 1, 2, 3, . . . . N objects and/or elements, where N is a positive integer with no upper bound. Therefore, as used herein, a set does not include a null set (i.e., an empty set), that includes no elements (for example, N=0 for the null set). A set may include only a single element. In other embodiments, a set may include a number of elements that is significantly greater than one, two, three, or billions of elements. A set may be an infinite set or a finite set. The objects included in some sets may be discrete objects (for example, the set of natural numbers N). The objects included in other sets may be continuous objects (for example, the set of real numbers R). In some embodiments, “a set of objects” that is not a null set of the objects may be interchangeably referred to as either “one or more objects” or “at least one object,” where the term “object” may stand for any object or element that may be included in a set. Accordingly, the phrases “one or more objects” and “at least one object” may be employed interchangeably to refer to a set of objects that is not the null or empty set of objects. A set of objects that includes at least two of the objects may be referred to as “a plurality of objects.”

As used herein and in one example, the term “subset,” is a set that is included in another set. A subset may be, but is not required to be, a proper or strict subset of the other set that the subset is included within. That is, if set B is a subset of set A, then in some embodiments, set B is a proper or strict subset of set A. In other embodiments, set B is a subset of set A, but not a proper or a strict subset of set A. For example, set A and set B may be equal sets, and set B may be referred to as a subset of set A. In such embodiments, set A may also be referred to as a subset of set B. Two sets may be disjointed sets if the intersection between the two sets is the null set.

As used herein, the terms “application” or “app” may be employed interchangeably to refer to any software-based program, package, or product that is executable via one or more (physical or virtual) computing machines or devices. An application may be any set of software products that, when executed, provide an end user one or more computational and/or data services. In some embodiments, an application may refer to a set of applications that may be executed together to provide the one or more computational and/or data services. The applications included in a set of applications may be executed serially, in parallel, or any combination thereof. The execution of multiple applications (comprising a single application) may be interleaved. For example, an application may include a first application and a second application. An execution of the application may include the serial execution of the first and second application or a parallel execution of the first and second applications. In other embodiments, the execution of the first and second application may be interleaved.

For purposes of a detailed discussion above, embodiments of the present disclosure are described with reference to a computing device or a distributed computing environment; however, the computing device and distributed computing environment depicted herein are non-limiting examples. Moreover, the terms computer system and computing system may be used interchangeably herein, such that a computer system is not limited to a single computing device, nor does a computing system require a plurality of computing devices. Rather, various aspects of the embodiments of this disclosure may be carried out on a single computing device or a plurality of computing devices, as described herein. Additionally, components can be configured for performing novel aspects of embodiments, where the term “configured for” can refer to “programmed to” perform particular tasks or implement particular abstract data types using code. Further, while embodiments of the present disclosure may generally refer to the technical solution environment and the schematics described herein, it is understood that the techniques described may be extended to other implementation contexts.

Many different arrangements of the various components depicted, as well as components not shown, are possible without departing from the scope of the claims below. Embodiments of the present disclosure have been described with the intent to be illustrative rather than restrictive. Alternative embodiments will become apparent to readers of this disclosure after and because of reading it. Alternative means of implementing the aforementioned can be completed without departing from the scope of the claims below. Certain features and sub-combinations are of utility and may be employed without reference to other features and sub-combinations and are contemplated within the scope of the claims.

1. A system comprising:
a memory component; and
a processing device coupled to the memory component, the processing device to perform operations comprising:
obtaining a video comprising a plurality of images;
selecting a pivot image from the plurality of images;
causing a first machine learning model to generate a descriptor based at least in part on the pivot image by at least providing the pivot image as an input to the first machine learning model, where the descriptor includes a language description of the pivot image; and
providing the pivot image and the descriptor to a decoder.

2. The system of claim 1, wherein the pivot image depicts a conceptual element of the video.

3. The system of claim 1, wherein selecting the pivot image further comprises selecting the pivot image from the plurality of images based on a second machine learning model detecting a change between two or more images of the plurality of images.

4. The system of claim 3, wherein the change comprises a modification to an object depicted in the two or more images that is detected, by the second machine learning model.

5. The system of claim 3, wherein the change comprises detecting, by the second machine learning model, an additional object relative to at least one image of the two or more images.

6. The system of claim 3, wherein causing the first machine learning model to generate the descriptor further comprises prompting the first machine learning model to describe a conceptual element of the video relative to the pivot image and at least one other image of the plurality of images.

7. The system of claim 3, wherein the processing device further performs operations causing, at the decoder, a third machine learning model to generate a reconstructed video by at least providing as a first input to the third machine learning model the pivot image and the descriptor, where the third machine learning model uses the pivot image and at least a portion of the descriptor to output a second plurality of images that are combined to generate the reconstructed video.

8. The system of claim 7, wherein the first machine learning model comprises a large language model, the second machine learning model comprises a neural network, and the third machine learning model comprises a diffusion model.

9. A non-transitory computer-readable medium storing executable instructions embodied thereon, that, when executed by a processing device, cause the processing device to perform operations comprising:
obtaining a pivot image from a video;
causing a machine learning model to generate a descriptor based at least in part on the pivot image, the descriptor providing a natural language description of the pivot image;
generating a compressed data object including the descriptor and the pivot image; and
providing the compressed data object to an endpoint over a network.

10. The medium of claim 9, wherein the medium further stores executable instructions, that, cause the processing device to perform operations causing a decoder executed by the endpoint to generate a reconstructed video by at least providing the descriptor and the pivot image as an input to a generative model.

11. The medium of claim 10, wherein the generative model generates intermediate frames of the reconstructed video between the pivot image and a second pivot image based at least in part on the descriptor.

12. The medium of claim 9, wherein obtaining the pivot image further comprises sampling frames of the video over an interval of time.

13. The medium of claim 9, wherein obtaining the pivot image further comprises causing a second machine learning model to determine the pivot image includes a conceptual element of the video.

14. The medium of claim 9, wherein the medium further stores executable instructions, that, cause the processing device to perform operations causing the machine learning model to generate a second descriptor that includes a second natural language description of a relationship between the set of pivot images and at least one other pivot image obtained from the video, where the pivot image of the at least one other pivot image are provided to the machine learning model as an input.

15. The medium of claim 9, wherein the machine learning model includes a large language model (LLM).

16. The medium of claim 9, wherein obtaining the pivot image further comprises causing the machine learning model to generate a second natural language description of a frame of the video and selecting the frame as the pivot image based at least in part on the second natural language description.

17. A method for video compression comprising:
obtaining a descriptor and a pivot image, the descriptor including a natural language description associated with the pivot image generated by a first machine learning model, the pivot image extracted from a video; and
causing a second machine learning model to generate reconstructed video based at least in part on the pivot image and the descriptor.

18. The method of claim 17, wherein the descriptor further includes a second natural language description of objects within the pivot image.

19. The method of claim 17, wherein causing the second machine learning model to generate the reconstructed video further comprises causing the second machine learning model to reconstruct a first version of the video.

20. The method of claim 17, wherein causing the second machine learning model to generate the reconstructed video further comprises combining a plurality of images generated by the second machine learning model based at least in part on the pivot image and the descriptor.
